(19) United States
(12) Patent Application Publication
(10) Pub. No.: US 2025/0294509 A1
(43) Pub. Date: Sep. 18, 2025

(54) LOCATING OBJECTS RELATIVE TO A GEOFENCE IN A REAL TIME LOCATION SYSTEM

(71) Applicant: FEDERAL EXPRESS CORPORATION, Memphis, TN (US)

(72) Inventors: Trenton C. FOX, Harrison, AR (US); Kevin C. HENRY, Harrison, AR (US)

(73) Assignee: FEDERAL EXPRESS CORPORATION, Memphis, TN (US)

(21) Appl. No.: 18/602,503

(22) Filed: Mar. 12, 2024

(51) Int. Cl. H04W 64/00; G06Q 10/0833; H04W 4/021

(52) U.S. Cl. CPC H04W 64/003; G06Q 10/0833; H04W 4/021

(57) ABSTRACT

Disclosed are methods and systems for tracking a plurality of objects configured to be transported by an object transport vehicle. The method includes determining a location of each object. A geofence is generated to surround a portion of the vehicle based on signals received from wireless devices affixed to a front portion and a rear portion of the vehicle. The geofence shapes varies based on a number of signals received. A confidence score is calculated for each object based on a distance of each object from a point within the geofence. A higher score is assigned to objects closer to the point than to objects farther from the point. The score of one object is increased if the one object is inside the geofence for a predetermined percentage of a time interval. The one object is associated with the vehicle if the score exceeds a threshold.

### TECHNICAL FIELD

The present disclosure generally relates to real time location systems. In particular, embodiments of the present disclosure relate to methods, systems, and devices for locating objects relative to a geofence in a real time location system.

### BACKGROUND

The efficient, safe, and secure shipment of freight, including but not limited to correspondence, materials, goods, components, and commercial products, is an important component in today's business, particularly in view of the international nature of most business enterprises. Freight often is shipped nationally and internationally by means of several different transportation devices, such as trucks, trains, ships, and airplanes. Before the freight reaches its destination, it is often handled by several different entities, such as truck companies, intermediate consolidators, railways, shipping companies, and airlines.

The parcels of freight may be exchanged between entities at different transfer points or hubs. At each hub, the parcels may be separated and transferred by different vehicles to different destinations. The parcels may be unloaded from a vehicle and then loaded onto another vehicle one or more times.

A wireless device (e.g., a tag) may be affixed to a parcel to help track a location of the parcel during shipment, including while in a hub (e.g., a warehouse). In some instances, the hub may contain many parcels that are placed relatively close together. For example, when a truck is being loaded, the parcels to be loaded onto the truck may be staged near the truck entrance prior to loading to expedite the loading process. An object transport vehicle (e.g., a forklift) may be used to load the parcels onto the truck. The vehicle may have one or more wireless devices affixed thereto, to help track the location of the vehicle in the hub.

Continuing the above example, to further expedite the truck loading process, the wireless device on each parcel may be “read” to identify the parcel and determine whether the forklift operator should load the “read” parcel onto the truck. But existing solutions do not provide sufficient accuracy and granularity in crowded environments (e.g., where there any many objects in a worksite) to correctly determine which object is being carried by an object transport vehicle at a specific point in time.

This issue often arises when a forklift, currently without any freight on its forks, approaches a shipment that is located in a noisy bay (i.e., an area in which there are multiple shipments placed relatively close together). What often happens is that pre-existing solutions would “lock” onto an incorrect shipment that is neighboring the actual shipment being picked up by the forklift. This incorrect “lock” is generally caused by variances in tag read strength that arise from manufacturing, tag placement on the shipment, the shipment's material, placement of nearby shipments, environmental properties (e.g., interference with receiving wireless signals transmitted by the tag), etc. With no technical corrective behavior, the forklift operator then needs to manually correct the “lock.” This technical inefficiency causes a downstream operational inefficiency, with the manual correction also interrupting the technical process. The present disclosure provides a system and method to correct that misbehavior and prevent the interruption.

It is therefore desirable to be able to determine whether a given parcel is being moved by a given object transport vehicle at a specific point in time.

### SUMMARY

According to some embodiments of the present disclosure, there is provided an object tracking system. The object tracking system includes a plurality of first wireless devices, a plurality of second wireless devices, a plurality of third wireless devices, and a controller. Each of the plurality of first wireless devices is associated with one of a plurality of objects. Each of the plurality of second wireless devices is affixed to a front portion an object transport vehicle. Each of the plurality of third wireless devices is affixed to a rear portion of the object transport vehicle. The controller is configured to determine a location of each of the plurality of objects based on a first signal associated with each of the plurality of first wireless devices; generate a geofence surrounding at least a portion of the object transport vehicle based on a plurality of second signals, each second signal associated with one of the plurality of second wireless devices, and a plurality of third signals, each third signal associated with one of the plurality of third wireless devices, wherein a shape of the geofence varies based on a number of second signals received and a number of third signals received; periodically determine a position of each of the plurality of objects relative to the geofence based on the determined location of each of the plurality of objects, wherein the position includes whether each of the plurality of objects is inside the geofence or outside the geofence; and periodically calculate a confidence score for each of the plurality of objects based on a distance of each of the plurality of objects from a point within the geofence, wherein a higher confidence score is assigned to objects closer to the point than to objects farther from the point. On a condition that the determined position for one of the plurality of objects indicates that the one object is inside the geofence for a predetermined period of time, the controller is further configured to increase the confidence score of the one object by a predetermined amount. On a condition that the confidence score for the one object exceeds a threshold, the controller is further configured to associate the one object with the object transport vehicle, wherein the one object is physically loaded on the object transport vehicle.

According to some embodiments of the present disclosure, there is provided a method for tracking a plurality of objects configured to be transported by an object transport vehicle. The method includes determining a location of each of the plurality of objects based on a first signal associated with each of a plurality of first wireless devices, wherein each of the plurality of first wireless devices is associated with one of a plurality of objects. A geofence is dynamically generated to surround at least a portion of the object transport vehicle based on a plurality of second signals, each second signal associated with one of a plurality of second wireless devices, and a plurality of third signals, each third signal associated with one of a plurality of third wireless devices. Each of the plurality of second wireless devices is affixed to a front portion the object transport vehicle. Each of the plurality of third wireless devices is affixed to a rear portion of the object transport vehicle. A shape of the geofence varies based on a number of second signals received and a number of third signals received. A position of each of the plurality of objects relative to the geofence is periodically determined based on the determined location of each of the plurality of objects, wherein the position includes whether each of the plurality of objects is inside the geofence or outside the geofence. A confidence score is periodically calculated for each of the plurality of objects based on a distance of each of the plurality of objects from a point within the geofence, wherein a higher confidence score is assigned to objects closer to the point than to objects farther from the point. The confidence score of one of the plurality of objects is increased by a predetermined amount on a condition that the determined position for the one object indicates that the one object is inside the geofence for a predetermined percentage of a time interval. The one object is associated with the object transport vehicle on a condition that the confidence score for the one object exceeds a threshold, wherein the one object is physically loaded on the object transport vehicle.

### BRIEF DESCRIPTION OF THE DRAWINGS

FIG. 1 is a schematic representation of a worksite, consistent with the disclosed embodiments.

FIG. 2 is a schematic representation of a top view of a forklift carrying a shipment on a pallet, consistent with the disclosed embodiments.

FIG. 3 is a block diagram of an object tracking system, consistent with the disclosed embodiments.

FIG. 4A is a schematic representation of a top view of a forklift carrying a shipment on a pallet and a rectangular geofence around the forklift, consistent with the disclosed embodiments.

FIG. 4B is a schematic representation of a top view of a forklift carrying a shipment on a pallet and a circular geofence around the forklift, consistent with the disclosed embodiments.

FIG. 5 is a flowchart of a method for locating objects relative to a geofence, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations, and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

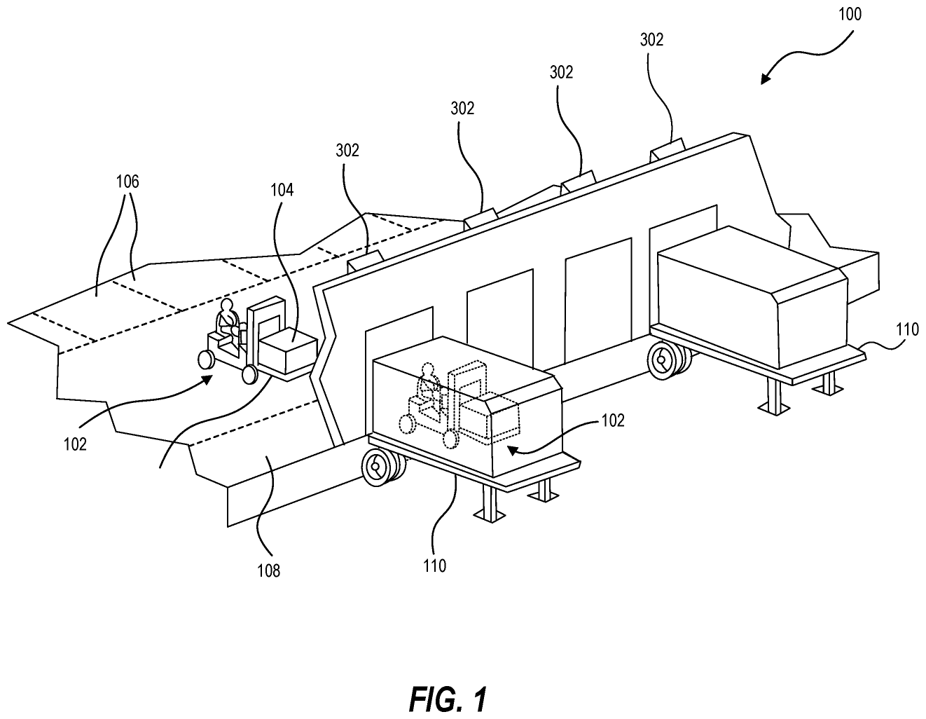

FIG. 1 illustrates a worksite 100, consistent with the disclosed embodiments. The worksite 100 may include one or more areas where one or more vehicles, such as forklifts 102, may load or unload one or more objects, such as shipments 104, packages, or other freight. For example, one forklift 102 may be used to pick up one or more shipments 104 at one location at the worksite 100 and transport the shipment(s) 104 to another location at the worksite 100. It is to be understood, however, that vehicles other than forklifts may be used to transport the shipment(s) 104. For example, other manned, semi-autonomous, or autonomous (unmanned) vehicles may be used to transport the shipment(s) 104, such as hand-trucks, carts, trailers, motor vehicles, or other vehicles. Such vehicles may also be referred to in this disclosure as “object transport vehicles.”

The worksite 100 may be at least partially located in a warehouse or other structure or building, as shown in FIG. 1. Alternatively, the worksite 100 may be partially or entirely outdoors. The worksite 100 may include one or more locations or zones where the shipments 104 may be unloaded and stored, either temporarily or for longer periods of time. For example, depending on the layout of the worksite 100, the forklifts 102 may transport the shipments 104 to and from different lanes 106, loading bays, docks 108, or other storage areas, or to and from other vehicles 110 (e.g., trailers, trucks, aircraft, ships, or other delivery vehicles, etc.) at the worksite 100. Although the worksite 100 shown in FIG. 1 includes a warehouse and surrounding area, it is to be understood that the worksite 100 may cover a larger area including multiple buildings.

In an embodiment, the worksite 100 may be a receiving and/or shipping facility, distribution center, or hub where the shipments 104 are received and/or shipped. One or more of the forklifts 102 may transport the shipments 104 within the worksite 100 so that the shipments 104 are loaded into the appropriate delivery vehicles leaving the worksite 100 or loaded into the appropriate storage areas at the worksite 100. Alternatively, it is to be understood that objects other than shipments may be transported and tracked using the systems and methods described below. Other inventory and objects may be tracked, depending on the application. The worksite 100 may include one or more readers 302 configured to receive wireless signals from wireless devices associated with an object transport vehicle (e.g., forklift 102) and an object (e.g., shipment 104), as will be described in further detail below.

The shipments 104 may be placed on and supported by a pallet 112, which may be loaded onto and unloaded from the forklifts 102. Alternatively, the forklifts 102 may include or carry another type of platform or surface on which the shipments 104 may be placed.

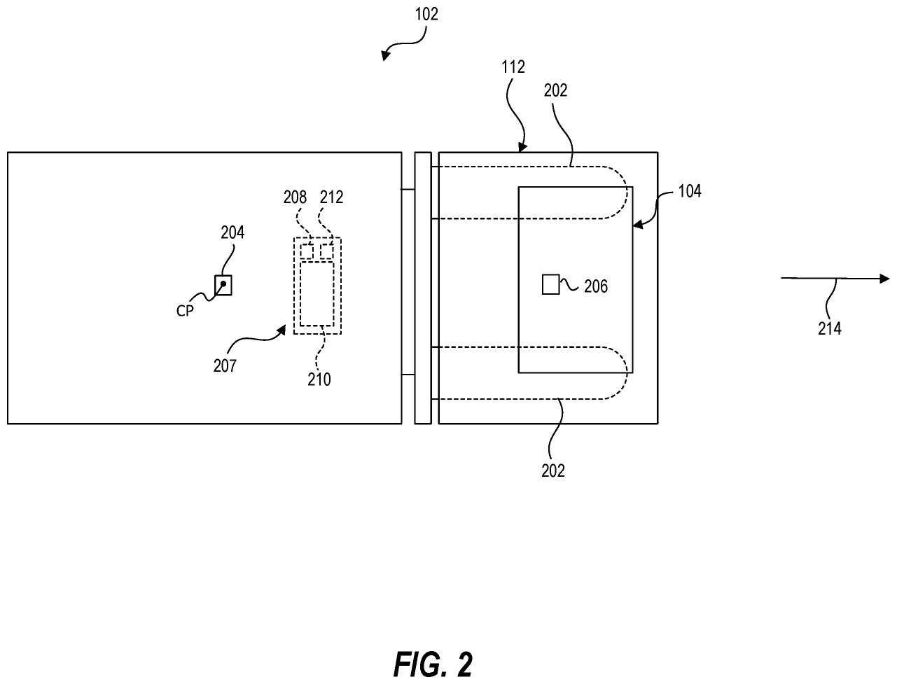

FIG. 2 is a schematic representation of a top view of a forklift 102 carrying the shipment 104 on the pallet 112, consistent with the disclosed embodiments. The forklift 102 may include forks 202 or another implement at a front end of the forklift 102 that engage the pallet 112 or shipment 104. The forklift 102 may also include a lift mechanism for lifting the forks 202 or other implement, thereby lifting the pallet 112 and/or shipment 104.

Each forklift 102 and shipment 104 may be provided with one or more wireless devices (e.g., forklift tags 204 and shipment tags 206) configured to transfer information. For example, the tags 204, 206 may include wireless devices configured to communicate via a wireless communications protocol, such as radio frequency identification (RFID), Bluetooth, Bluetooth Low Energy (BLE), Wi-Fi, near field communication (NFC), global positioning system (GPS), or other wireless communication protocols. It is noted that the terms “tag” and “wireless device” may be used interchangeably in this disclosure. The tags 204, 206 or other devices may be applied using adhesive to the forklift 102 or shipment 104, e.g., using a label that is embedded or printed with the tags 204, 206. Alternatively, the tags 204, 206 or other devices may be applied using other attachment methods. For example, when applying the tags 204 to vehicles, such as the forklifts 102, the tags 204 may be applied using screws, rivets, welds, etc. For the forklift tag 204, the information may include identification information (e.g., a unique identifier or other information identifying the forklift 102). For the shipment tag 206, the information may include identification information (e.g., a unique identifier or other information identifying the shipment 104 and/or the contents within the shipment 104) or other tracking information (e.g., the origin, interim, or destination locations, or other information associated with the shipment 104). The unique identifier for the shipment 104 may include one or more alphanumeric characters and/or symbols assigned to the shipment 104, such as a progressive number (PRO number) for tracking the shipment 104 as known in the art.

Each forklift 102 may include one or more forklift tags 204. The forklift tag(s) 204 may be placed at a central location of the forklift 102, as shown in FIG. 2. Although FIG. 2 shows a single forklift tag 204, each forklift 102 may include a plurality of forklift tags 204, e.g., eight tags 204. Some of the tags 204 may be located closer to the top of the forklift 102 and some of the tags 204 may be located closer to the wheels of the forklift 102. Alternatively, the forklift 102 may include fewer than eight tags 204 (e.g., two or four tags) or more than eight tags 204. In some embodiments, some of the tags 204 may be located at a front portion of the forklift 102 (e.g., a portion of the forklift 102 close to the forks 202, such as the forklift mast) and some of the tags 204 may be located at a rear portion of the forklift 102. As described below, a controller may be configured to receive wireless signals from the plurality of the forklift tags 204 to identify a center point (CP) of the forklift 102, and the controller may use the center point of the forklift 102 to identify the location of the forklift 102 in the worksite 100.

Each forklift 102 may further include an onboard system configured to allow the operator to monitor various operations of the forklift 102. For example, each forklift 102 may include a control system 207 including a direction determining device 208, an operator display device 210, and a communication device 212.

The direction determining device 208 may be configured to determine an orientation or a direction of travel 214 of the forklift 102. For example, the direction determining device 208 may include a digital compass that may indicate the direction of travel 214 in a frame of reference defined by cardinal directions (e.g., north, south, east, west), intercardinal directions (e.g., northeast, northwest, southeast, southwest), and/or intermediate directions between the cardinal and intercardinal directions. In some embodiments, the direction determining device 208 may be configured to determine the direction of travel 214 relative to a coordinate system internal to the worksite 100. For example, a predetermined location in the worksite 100 may be designated with the coordinate point 0, 0 (i.e., an origin point) and the location and direction of travel of the forklift may be determined relative to the coordinate point 0, 0.

The operator display device 210 may include one or more monitors (e.g., a liquid crystal display (LCD), a cathode ray tube (CRT), a plasma display, a touch-screen, a portable hand-held device (e.g., a smartphone), a projection display device (e.g., a heads-up display), or any such display device known in the art) configured to actively and responsively display information to the operator of the forklift 102. The operator display device 210 may display images in response to signals provided by the control system of the forklift 102 and information received from a controller 304, as described below.

The communication device 212 may include any device configured to facilitate communications between the forklift 102 and the controller 304. For example, the communication device 212 may include an antenna, a transmitter, a receiver, and/or any other devices that enable the forklift 102 to wirelessly exchange information (e.g., signals from the control system 207, the direction determining device 208, etc.) with the controller 304 via a communication link. In some embodiments, the communication device 212 may be configured to communicate with the controller 304 via a wireless communication technology, such as Wi-Fi (e.g., an IEEE 802.11-based protocol), Bluetooth®, cellular technologies (i.e., 3G, 4G, 5G, 6G, or other 3GPP-related protocol), RFID, near field communication (NFC), global positioning system (GPS), or other wireless communication technologies.

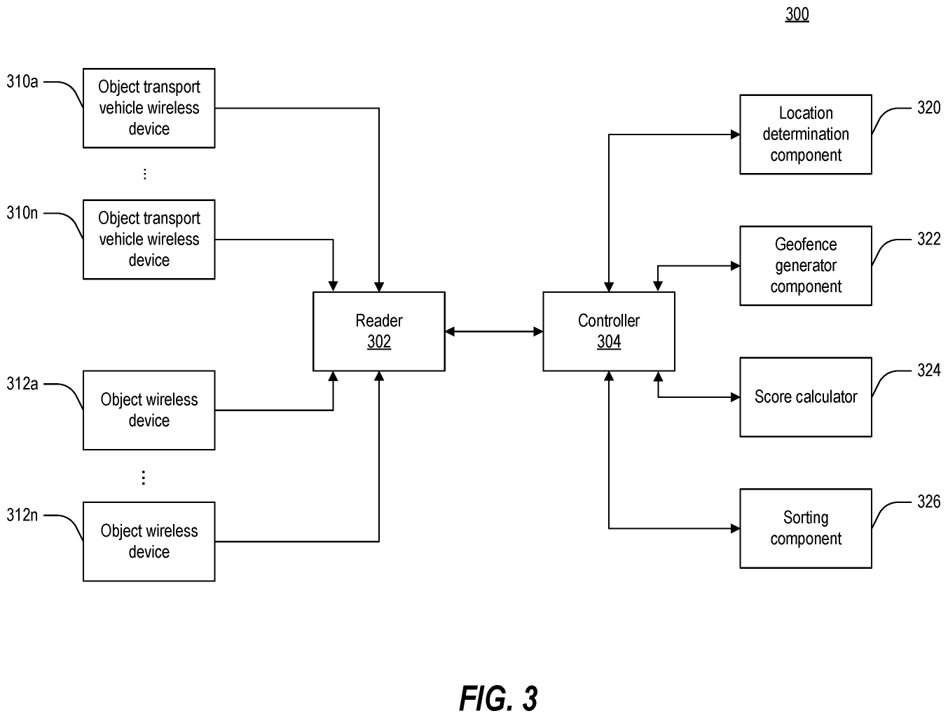

FIG. 3 is a block diagram of an object tracking system 300, consistent with the disclosed embodiments. The object tracking system 300 may include a reader 302 and a controller 304. The reader 302 may be configured to receive wireless signals from wireless devices, such as forklift tags 204 and shipment tags 206. For example, the reader 302 and the forklift tags 204 and the shipment tags 206 may be associated with a real time locating system (RTLS) as known in the art. In some embodiments, the system 300 may include one or more readers 302. The readers 302 may be configured to receive wireless signals in accordance with one or more wireless communication technologies. For example, the readers 302 may be configured to receive wireless signals according to any one or more of Wi-Fi (e.g., an IEEE 802.11-based protocol), Bluetooth®, cellular technologies (i.e., 3G, 4G, 5G, 6G, or other 3GPP-related protocol), RFID, near field communication (NFC), global positioning system (GPS), ultra-high frequency (UHF) radio waves, or other wireless communication technologies.

In the embodiment shown in FIG. 1, the readers 302 may be mounted to a wall at the worksite 100. Alternatively or in addition, the readers 302 may be mounted to a ceiling, and/or mounted or placed on a surface at or near the worksite 100. The number and location of the readers 302 may depend on the relative strength of the signals from the forklift tags 204 and the shipment tags 206. In some embodiments (e.g., when the tags 204, 206 supply relatively stronger signals), fewer readers 302 may be provided and may be located on or near the worksite 100, or remotely from the worksite 100. Alternatively (e.g., when the tags 204, 206 supply relatively weaker signals), an array of readers 302 may be provided and may be located on and/or near the worksite 100, e.g., at spaced-apart intervals along the ceiling and/or walls of the worksite 100.

The forklift tags 204 and the shipment tags 206 may be RFID tags, which may be active, semi-passive, or passive. Passive tags may be powered entirely by signals from the reader 302. Active and semi-passive tags may include a power source (e.g., a battery) to power its circuits. Semi-passive tags may also rely on the reader 302 to supply its power for certain functions, such as communicating with the reader 302. The readers 302 may use wireless non-contact radio-frequency electromagnetic fields to transfer information for the purpose of automatically identifying and tracking the forklifts 102 and shipments 104 to which the tags 204, 206 are attached. For example, each reader 302 may periodically send signals in an area surrounding the reader 302 and receive responses from the tags 204, 206 that are located within the area surrounding the reader 302.

Referring back to FIG. 3, the reader 302 may be configured to receive wireless signals from object transport vehicle wireless devices 310a-310n (e.g., forklift tags 204) and wireless signals from object wireless devices 312a-312n (e.g., shipment tags 206). The reader 302 may be configured to communicate with a controller 304 via a wired connection or wireless connection. For example, the reader 302 may be configured to send information from the object transport vehicle wireless devices 310a-310n and the object wireless devices 312a-312n to the controller 304.

The controller 304 may be configured to perform various operations based on the information received from the object transport vehicle wireless devices 310a-310n and the object wireless devices 312a-312n. The controller 304 may be configured to communicate with a location determination component 320, a geofence generator component 322, a score calculator 324, and a sorting component 326. While shown in FIG. 3 as separate components, the location determination component 320, the geofence generator component 322, the score calculator 324, and the sorting component 326 may be operations performed by the controller 304 or may be components included in the controller 304. The components 320-326 may be implemented in hardware, software, or a combination thereof. In some embodiments, the controller 304 and/or the components 320-326 may be implemented as a processor, e.g., a central processing unit (CPU) with one or more processing cores, a graphics processing unit (GPU), an application-specific integrated circuit (ASIC), a digital signal processor (DSP), a field programmable gate array (FPGA), or other circuitry.

The location determination component 320 may be configured to determine a location of object transport vehicles and objects in the worksite 100 in real time or near-real time based on wireless signals received from the wireless devices on the object transport vehicle and on the objects in the worksite 100. The signals from the wireless devices may be received by the reader 302 and passed to the controller 304 and the location determination component 320. For example, assume that an object transport vehicle (e.g., forklift 102) has eight wireless devices (e.g., forklift tags 204) located on the vehicle. The location determination component 320 may calculate an average position of each of the eight wireless devices to determine a center point (CP) of the vehicle, in a similar manner as described in connection with FIG. 2. In some embodiments, the location of an object may be indicated by a point on an x, y coordinate plane with no assumed size for the object. In some embodiments, the location of the object may be determined to be within a variable radius of the determined location based on the wireless signals received from the wireless devices. For example, the variable radius may be approximately three feet or one meter.

The geofence generator component 322 may be configured to generate a geofence around an object transport vehicle. For example, the geofence generator component 322 may generate a geofence in different shapes around the vehicle, such as a rectangle or a circle, based on the determined center point of the vehicle. In some embodiments, a size of the geofence may extend a predetermined distance from an edge of the vehicle or from the center point of the vehicle. In some embodiments, the size and shape of the geofence may be defined in a configuration file and may be retrieved from the configuration file to generate the geofence. In some embodiments, the geofence may be projected relative to a center point of the object transport vehicle or relative to a center point of the front mast of the object transport vehicle (e.g., a forklift). For example, the center point of the front mast of the object transport vehicle may be determined by calculating an average location of the wireless devices attached to the front mast of the object transport vehicle.

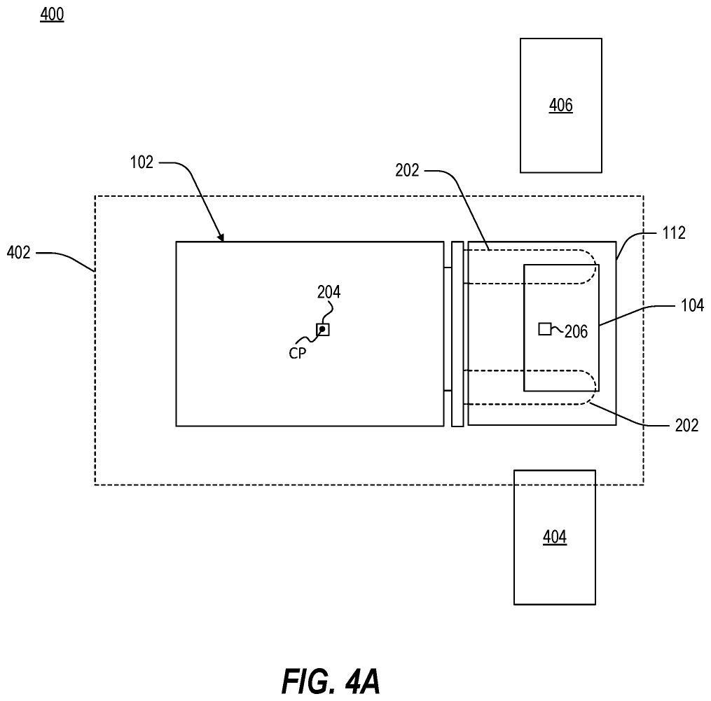

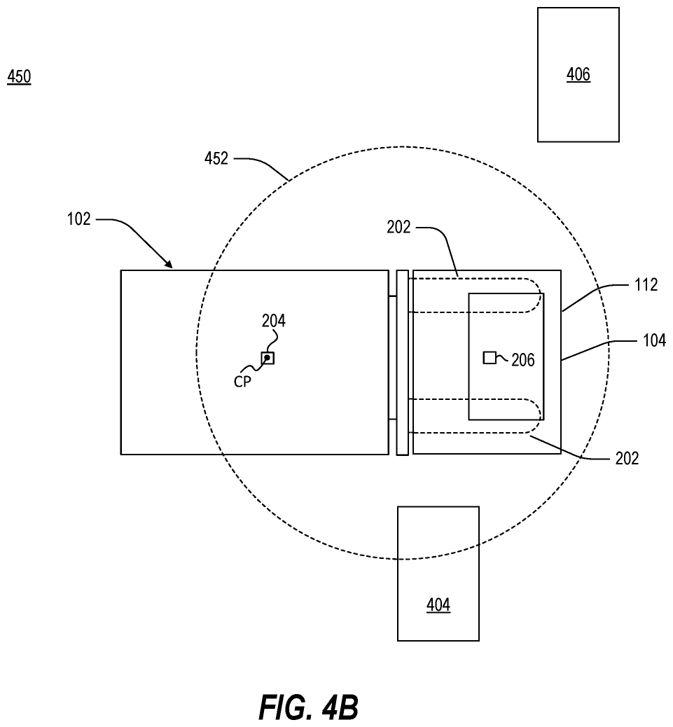

FIG. 4A is a schematic representation of a top view 400 of a forklift 102 carrying a shipment 104 on a pallet 112 and a rectangular geofence 402 around the forklift 102, consistent with the disclosed embodiments. For example, the geofence 402 may extend a predetermined distance away from the edges of the forklift 102, to form a rectangular shape. In some embodiments, each side of the geofence 402 may extend a different predetermined distance from an edge of the forklift 402. For example, as shown in FIG. 4A, the right side of the geofence 402 may extend a larger distance away from the front edge of the forklift 102 (as compared to the distance of the left side of the geofence 402 from the rear edge of the forklift 102), to accommodate a large-sized shipment 104 or pallet 112. Shipment 104 (shown in FIG. 4A as being on the forks 202 of the forklift 102) is located fully inside the geofence 402. A first shipment 404 (which may or may not be on a pallet) may be located partially inside the geofence 402 and partially outside the geofence 402. A second shipment 406 (which may or may not be on a pallet) may be located completely outside the geofence 402.

FIG. 4B is a schematic representation of a top view 450 of a forklift 102 carrying a shipment 104 on a pallet 112 and a circular geofence 452 around a portion of the forklift 102, consistent with the disclosed embodiments. For example, the center point of the geofence 452 may be shifted away from the center point of the forklift 102, such that an edge of the geofence 452 extends a predetermined distance away from the forks 202 of the forklift 102. As another example, the geofence 452 may extend a predetermined radius away the center point (CP) the forklift 102, to form the circular shape. Shipment 104 (shown in FIG. 4B as being on the forks 202 of the forklift 102) is located fully inside the geofence 452. The first shipment 404 (which may or may not be on a pallet) may be located partially inside the geofence 452 and partially outside the geofence 452. The second shipment 406 (which may or may not be on a pallet) may be located completely outside the geofence 452.

In some embodiments, the circular geofence 452 may have a variable radius. For example, the variable radius may be determined from a center of the forklift. The geofence generator component 322 may average the location as determined by the wireless devices on the front of the forklift and average the location as determined by the wireless devices on the back of the forklift. The geofence generator component 322 may then average the front average and the back average to determine the center of the forklift, not including the forks themselves. The geofence generator component 322 may then project the circular geofence out from this determined center of the forklift.

It is noted that other shapes of the geofence are contemplated to be within the scope of the present disclosure. For example, the geofence may have a rounded rectangle shape, with semicircular portions in front of the forks 202 of the forklift 102 and behind the forklift 102. As another example, the geofence may have an oval shape, centered around the center point of the forklift 102. It is noted that in some embodiments, a rectangular geofence may provide a higher granularity of scores than a circular geofence.

In some embodiments, a circular geofence may be used when the rear tags on a forklift cannot be read (i.e., no wireless signals are received from the wireless devices attached to the rear of the object transport vehicle). For example, the rear tags may be broken, the wireless signals from the rear tags may obscured because of the environment, or the rear tags may have been used beyond their lifespan. In some embodiments, the circular geofence may be simultaneously used along with a set of variously sized rectangular geofences. The circular geofence as an addition to the rectangular geofence set has an advantage in that the circular geofence can “read” a large area around the forklift, which may be useful in areas where environmental conditions cause reflections and/or when the forklift is turning, which can cause the perceived location of the tag to “drift” towards a nearby reader before being corrected. In some embodiments, rectangular geofences may be preferred because the rectangular geofences can be projected directly over the already rectangular area of the forks, for example. The rectangular geofences may allow more precision in determining the location of objects within the geofence. Rectangular geofences can also be more easily composed together without gaps and/or overlaps. In some embodiments, a set of rectangular geofences may be provided that account for:

(1) An area directly around the forks.

(2) An area surrounding the fork-area geofence that may be, for example, twice as wide and three times as long. This size geofence helps to account for longer freight where the shipment tag may be placed farther out (e.g., placed closer to an outer edge of the shipment).

(3) A geofence surrounding both prior fences, but again is slightly longer and wider. This size geofence may be useful when the forklift is turning.

(4) A geofence that is placed farther back on the forklift, which accounts for a backwards “drift” (based on the reading of the forklift tags) when the forklift accelerates forwards.

In some embodiments, each of the geofences may have a weight assigned to it which is used when the score is calculated. In this case, the score may decrease as later-listed geofences are applied because the size of the geofence increases and a shipment that indicates are being inside the geofence may in fact not be loaded onto the forklift.

In some embodiments, the geofence generator component 322 may determine the shape of the geofence based on whether all the wireless devices (e.g., forklift tags 204) are functioning properly. In some embodiments, the wireless signal received from each wireless device may include an identifier of the wireless device. The position of the wireless device on the object transport vehicle is known (e.g., may be recorded in a storage accessible by the controller 304) such that it may be determined (e.g., by the geofence generator component 322) which wireless device each wireless signal is received from. For example, assume that there are four wireless devices located on a front of the forklift and four wireless devices located on a back of the forklift. If the wireless devices on the back of the forklift are non-functioning (i.e., are disabled, broken, etc.), then the geofence generator component 322 may generate a circular geofence, with a center point of the geofence based on an average location determined from the wireless devices located on the front of the forklift. In some embodiments, the size of the geofence and the shape of the geofence may be dynamically adaptable based on the signals received from the wireless devices on the object transport vehicle (e.g., forklift 102). For example, if all wireless devices on the forklift 102 are functioning properly, then the geofence generator component 322 may generate a rectangular geofence. But if the forklift 102 backs into a wall and the wireless devices on the rear of the forklift are damaged, then the geofence generator component 322 may generate a circular geofence as described above.

Referring back to FIG. 3, the score calculator 324 may be configured to calculate a score for objects (e.g., shipments 104) in the worksite 100. For example, the score calculator 324 may calculate a score for each object based on the location of the object relative to the object transport vehicle and/or to the boundaries of the geofence (e.g., whether the object is located fully inside the geofence, partially inside the geofence, or fully outside the geofence).

In some embodiments, the score may be calculated as follows. All wireless devices (e.g., tags) within a configurable proximity to a center of the object transport vehicle (e.g., forklift) are identified. This is performed to narrow the scope of the number of wireless devices that are to be examined. All the geofences for the object transport vehicle are sorted according to a weight assigned to the geofence, from highest weight to lowest weight. For each wireless device on a list of nearby wireless devices, the process iterates through each geofence to determine if the wireless device is within the bounds of the geofence. As soon as a geofence is found where this condition is true (i.e., the wireless device is inside the geofence), the weight for that geofence is added to the score of the wireless device. Since the geofences are sorted by their weights, and the weights are assigned by nearness to the front forks (assuming that the object transport vehicle is a forklift), this means that only the highest priority geofence and its weight is applied. The next wireless device is then processed according to the same rules, until all wireless devices in the nearby wireless device list have had their scores adjusted.

Once all wireless devices have been evaluated, in-fence averaging is performed over the list of wireless devices to further adjust scores depending on their consistency. A time window having a predetermined length (e.g., between 1-5 seconds) may be used to evaluate the shipments. Each shipment is periodically “read” within the time window, for example, every 0.5 seconds. A percentage of the “reads” during the time window that the shipment spends within the geofence is calculated. For example, if the time window is 5 seconds and each wireless device is “read” every 0.5 seconds, there will be a total of 10 “reads” during the time window. Based on the percentage of the “reads” that the shipment spends within the geofence, each shipment in the list is compared to its neighbors in the list. During this comparison, if a difference between the calculated percentages spent inside the geofence exceeds a predetermined threshold (e.g., if one shipment has 10% or more “reads” inside the geofence than its neighboring shipments), the scores of the shipments involved in the comparison may be adjusted by a predetermined amount. For example, the score of the shipment that has spent the most “reads” inside the geofence may have its score increased by five points. It is noted that other types of score increases are possible, such as a different number of points or a predetermined percentage score increase (e.g., a 5% increase). The scores for the shipments are then sorted according to the now-adjusted score.

For example, as shown in FIG. 4A, the shipment 104 is located fully inside the geofence 402, the shipment 404 is located partially inside the geofence 402, and the shipment 406 is located fully outside the geofence 402. Based on these locations, the score calculator 324 may calculate the shipment 104 as having a highest score, the shipment 404 as having the second highest score, and the shipment 406 as having the lowest score. The score may be calculated based on any applicable relative scoring scale, e.g., 0 to 100, 0.0 to 1.0, etc.

In some embodiments, the closer a shipment is to the forks 202 of the forklift 102, the higher the score assigned to the shipment. In such an embodiment, the controller 304 may use the score to determine a likelihood that a particular shipment is being carried by the forklift 102, with the highest score indicating a higher likelihood that the shipment is loaded on the forks 202 of the forklift 102. In other embodiments, the object transport vehicle may be a vehicle other than a forklift and a higher score may be based on proximity of the shipment to a center point or other reference point of the object transport vehicle. For example, if the object transport vehicle is a flatbed cart, a higher score may be based on proximity of the shipment to a center point of the cart. In some embodiments, a higher score may indicate that the object transport vehicle is transporting the object (i.e., shipment). In some embodiments, any objects that are detected but located outside the geofence may not be considered for scoring or may be considered for scoring but assigned an arbitrarily low score (e.g., assigned a “0” or a “1” on a scale of 0 to 100).

In some embodiments, an in-memory database may be used within the score calculator 324 to store the scores. In some embodiments, the score calculator 324 may be configured to output a list of scores. In some embodiments, the list of scores may be sent to the object transport vehicle which may then further process the list to determine which object is being carried by the object transport vehicle.

Referring to FIG. 2, the control system 207 of the forklift 102 may receive the list of scores and process the list to determine which shipment on the list is being carried by the forklift 102. The shipment being carried by the forklift 102 may be displayed on the operator display device 210. In some embodiments, the controller 304 may be further configured to process the list of scores to determine which shipment on the list is being carried by the forklift 102. The controller 304 may then send a message to the forklift 102 (received via the communication device 212) to display the shipment being carried on the forklift 102 on the operator display device 210.

Referring back to FIG. 3, the sorting component 326 may be configured to sort the scored objects in the worksite 100. For example, the sorting component 326 may sort the scored objects from the highest score to a lowest score, with the object having the highest score being considered as “associated with” the object transport vehicle. For example, the object with the highest score may indicate a high likelihood that the object is being carried by the object transport vehicle.

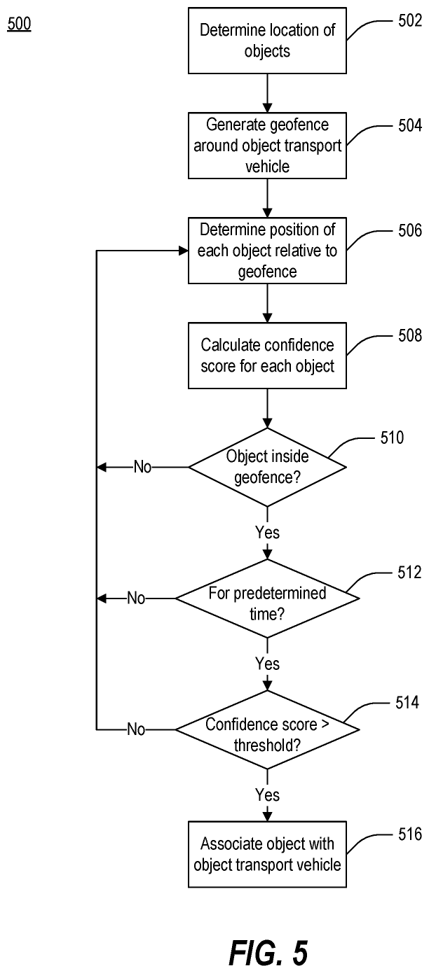

FIG. 5 is a flowchart of a method 500 for locating objects relative to a geofence, consistent with the disclosed embodiments. In some embodiments, the method 500 may be performed by the controller 304 described in connection with FIG. 3, while in other embodiments the method 500 may be performed another device (including those not pictured in FIG. 3).

A location of objects in the worksite 100 is determined (step 502). For example, the location of an object transport vehicle (e.g., forklift 102) and the locations of one or more objects (e.g., shipment 104) may be determined by receiving location information from a wireless device associated with (e.g., attached to) the object transport vehicle (e.g., tag 204) and the objects (e.g., tag 206). The tags 204, 206 may be read by a reader 302, as described in connection with FIG. 3. In some embodiments, step 502 may be performed by the location determination component 320, as described in connection with FIG. 3.

A geofence is generated around the object transport vehicle (step 504). For example, the geofence may be a rectangular shape or a circular shape around the object transport vehicle, as described in connection with FIGS. 4A and 4B. In some embodiments, step 504 may be performed by the geofence generator component 322, as described in connection with FIG. 3. When the geofence is generated, the qualities of the geofence can vary. For example, the dimensions of the geofence may vary along with the scores that are applied to an object, as described elsewhere in this disclosure.

The position of each object is determined relative to the geofence (step 506). For example, an object may be located fully inside the geofence, partially inside the geofence, or fully outside the geofence, as described in connection with FIGS. 4A and 4B.

A confidence score for each object is calculated (step 508). For example, the confidence score may indicate a likelihood that a given object is loaded on the object transport vehicle, with a higher confidence score indicating a higher likelihood. In some embodiments, step 508 may be performed by the score calculator 324, as described in connection with FIG. 3.

In some embodiments, the controller 304 may apply a series of geofences, as described elsewhere in this disclosure. For example, the controller 304 may apply a series of six different geofences. In some embodiments, the series of geofences may include more or less than six geofences. For example, the series of geofences may all be rectangular in shape and may have different dimensions relative to the shape of the object transport vehicle. For example, as shown in FIG. 4A, the geofence 402 may extend certain distances from the different edges of the forklift 102 to form a rectangular shape for the geofence 402. In some embodiments, the closer an object is to the forks 202 of the forklift 102, the higher the confidence score for the object.

The controller 304 evaluates each object based on its confidence score and an amount of time that the object is located inside the geofence. For example, as the object tracking vehicle moves through the worksite 100, it is desirable to determine which objects (if any) are being carried by the object tracking vehicle. An object being carried by the object tracking vehicle will have a high confidence score for a longer period of time. Other objects not being carried by the object tracking vehicle will have a changing confidence score. For example, as the object tracking vehicle moves farther away from an object, the confidence score for that object will decrease.

A determination is made whether an object is located inside the geofence (step 510). For example, the controller 304 may determine whether an object is located fully inside the geofence, partially inside the geofence, or fully outside the geofence, as described in connection with FIGS. 4A and 4B. In some embodiments, the controller 304 may make this determination by comparing the location of the object to the boundaries of the geofence. If an object is not located fully inside the geofence (step 510, “no” branch), then the method 500 returns to step 506 to determine the position of other objects relative to the geofence.

If the object is located fully inside the geofence (step 510, “yes” branch), then a determination is made whether the object is located fully inside the geofence for a predetermined period of time (step 512). As noted above, as the object transport vehicle moves around in the worksite 100, objects will move inside the geofence and outside the geofence. An object that is being carried by the object transport vehicle will move with the object transport vehicle and will therefore be inside the geofence for the predetermined period of time. In some embodiments, the method 500 may be performed periodically such that the locations of the object transport vehicle and the objects may be determined in real time or near-real time (i.e., the method 500 may be performed every two seconds). In some embodiments, the time window in which the method is performed may be configurable.

If the object is not located fully inside the geofence for the predetermined period of time (step 512, “no” branch), then the method 500 returns to step 506 to determine the position of other objects relative to the geofence. If the object is located fully inside the geofence for the predetermined period of time (step 512, “yes” branch), then a determination is made whether the confidence score for the object exceeds a predetermined threshold (step 514). As described above, the closer an object is to the object transport vehicle, the more likely it is that the object is being carried by the object transport vehicle (i.e., is “associated with” the object transport vehicle). If the confidence score for the object does not exceed the predetermined threshold (step 514, “no” branch), then the method 500 returns to step 506 to determine the position of other objects relative to the geofence.

If the confidence score for the object exceeds the predetermined threshold (step 514, “yes” branch), then the object is associated with the object transport vehicle (step 516). As used herein, when an object is “associated” with an object transport vehicle, it indicates a high likelihood that the object is being carried by the object transport vehicle. In some embodiments, the association between the object and the object transport vehicle may be stored in an entry in a database or other data storage. For example, the data storage may be accessible by the controller 304.

In some embodiments, an object that is consistently located inside the geofence may receive a confidence score increase. For example, in noisy scenarios (e.g., a large number of objects close together), an object might temporarily have a higher score because it “reads better” (i.e., the wireless device attached to the object provides a better signal), reads as being inside the geofence, and then reads as being back outside of the geofence (possibly on successive reads) because the object is at an edge of the geofence. For example, the layout of the worksite 100 may create obstacles that interfere with the wireless signals received by the reader 302 (e.g., the structure of the worksite, such as a steel beam, may interfere with the wireless signal reception by the reader 302). This reading of the wireless devices inside and outside the geofence may cause the score for an object to suddenly become the highest score, providing a false indication that the object is loaded onto the object transport vehicle, when it actually is not.

Objects that are not bouncing inside and outside the geofence may receive a higher score, e.g., have their score increased by spending more time inside the geofence. For example, the score increase may be a predetermined number of points added to the confidence score for the object. In some embodiments, the predetermined number of points may be configurable. By increasing the score for objects that stay inside the geofence for the predetermined period of time, the object with the highest confidence score is more likely to be the object that is actually loaded onto the object transport vehicle.

In some embodiments, objects that are bouncing inside and outside the geofence may receive a negative score. In these embodiments, the negative score may be raised to zero because the scores may be used by systems other than the real time location system and the other systems may not accept a negative score.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, Go, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations, and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. Disclosed embodiments may, moreover, include any one of the features in the claims, alone or in combination with one or more other feature in the claims, whether implemented as a method, by at least one processor, and/or stored as executable instructions on non-transitory computer readable media.

It is intended, therefore, that the specification and examples be considered as illustrative only, with a true scope being indicated by the following claims and their full scope of equivalents.

What is claimed is:

1. An object tracking system, comprising:
a plurality of first wireless devices, wherein each of the plurality of first wireless devices is associated with one of a plurality of objects;
a plurality of second wireless devices affixed to a front portion an object transport vehicle;
a plurality of third wireless devices affixed to a rear portion of the object transport vehicle; and
a controller configured to:
determine a location of each of the plurality of objects based on a first signal associated with each of the plurality of first wireless devices;
generate a geofence surrounding at least a portion of the object transport vehicle based on a plurality of second signals, each second signal associated with one of the plurality of second wireless devices, and a plurality of third signals, each third signal associated with one of the plurality of third wireless devices, wherein a shape of the geofence varies based on a number of second signals received and a number of third signals received;
periodically determine a position of each of the plurality of objects relative to the geofence based on the determined location of each of the plurality of objects, wherein the position includes whether each of the plurality of objects is inside the geofence or outside the geofence;
periodically calculate a confidence score for each of the plurality of objects based on a distance of each of the plurality of objects from a point within the geofence, wherein a higher confidence score is assigned to objects closer to the point than to objects farther from the point;
on a condition that the determined position for one of the plurality of objects indicates that the one object is inside the geofence for a predetermined period of time, increasing the confidence score of the one object by a predetermined amount; and
on a condition that the confidence score for the one object exceeds a threshold, associate the one object with the object transport vehicle, wherein the one object is physically loaded on the object transport vehicle.

2. The object tracking system of claim 1, wherein the controller is further configured to:
dynamically generate the geofence based on the number of second signals received and the number of third signals received.

3. The object tracking system of claim 2, wherein dynamically generating the geofence includes changing a shape of the geofence based on the number of second signals received and the number of third signals received.

4. The object tracking system of claim 1, wherein:
each second signal provides location information; and
the controller is further configured to:
on a condition that no third signals are received, generate the geofence as a circular shape with a center of the geofence based on an average location based on the second signals received.

5. The object tracking system of claim 1, wherein the controller is further configured to:
determine the plurality of objects based on a circular area around the object transport vehicle, wherein:
each second signal and each third signal provides location information;
a center of the circular area is determined based on an average location based on the second signals received and the third signals received; and
a radius of the circular area is a predetermined distance from the center, whereby any object within the circular area is included in the plurality of objects.

6. The object tracking system of claim 1, wherein the controller is further configured to:
periodically determine a position of each of the plurality of objects and periodically calculate the confidence score for each of the plurality of objects at a same time interval.

7. The object tracking system of claim 6, wherein the time interval is 0.5 seconds or 1 second.

8. The object tracking system of claim 6, wherein the predetermined period of time is longer than the time interval.

9. The object tracking system of claim 8, wherein the predetermined period of time is 2 seconds.

10. The object tracking system of claim 1, wherein the association between the one object and the object tracking vehicle is stored in an entry in a database.

11. The object tracking system of claim 1, wherein the controller is further configured to:
on a condition that the confidence score for one of the plurality of objects is a negative value, changing the confidence score for the one object to zero.

12. The object tracking system of claim 1, wherein each of the plurality of first wireless devices is a position sensor configured to generate the first signal.

13. The object tracking system of claim 1, wherein:
each of the plurality of second wireless devices is a position sensor configured to generate the second signal; and
each of the plurality of third wireless devices is a position sensor configured to generate the third signal.

14. The object tracking system of claim 1, wherein the controller is further configured to:
sort each of the plurality of objects from a highest confidence score to a lowest confidence score; and
associate one object of the plurality of objects with the highest confidence score with the object transport vehicle on a condition that the confidence score for the one object exceeds the threshold, wherein the one object is physically loaded on the object transport vehicle.

15. A method for tracking a plurality of objects configured to be transported by an object transport vehicle, the method comprising:
determining a location of each of the plurality of objects based on a first signal associated with each of a plurality of first wireless devices, wherein each of the plurality of first wireless devices is associated with one of a plurality of objects;
dynamically generate a geofence surrounding at least a portion of the object transport vehicle based on a plurality of second signals, each second signal associated with one of a plurality of second wireless devices, and a plurality of third signals, each third signal associated with one of a plurality of third wireless devices, wherein:
each of the plurality of second wireless devices is affixed to a front portion the object transport vehicle;
each of the plurality of third wireless devices is affixed to a rear portion of the object transport vehicle; and
a shape of the geofence varies based on a number of second signals received and a number of third signals received;
periodically determine a position of each of the plurality of objects relative to the geofence based on the determined location of each of the plurality of objects, wherein the position includes whether each of the plurality of objects is inside the geofence or outside the geofence;
periodically calculate a confidence score for each of the plurality of objects based on a distance of each of the plurality of objects from a point within the geofence, wherein a higher confidence score is assigned to objects closer to the point than to objects farther from the point;
increasing the confidence score of one of the plurality of objects by a predetermined amount on a condition that the determined position for the one object indicates that the one object is inside the geofence for a predetermined percentage of a time interval; and
associating the one object with the object transport vehicle on a condition that the confidence score for the one object exceeds a threshold, wherein the one object is physically loaded on the object transport vehicle.

16. The method of claim 15, further comprising:
determining the plurality of objects based on a circular area around the object transport vehicle, wherein:
each second signal and each third signal provides location information;
a center of the circular area is determined based on an average location based on the second signals received and the third signals received; and
a radius of the circular area is a predetermined distance from the center, whereby any object within the circular area is included in the plurality of objects.

17. The method of claim 15, further comprising:
periodically determining a position of each of the plurality of objects and periodically calculating the confidence score for each of the plurality of objects at a same time interval.

18. The method of claim 17, wherein the time interval is 0.5 seconds or 1 second.

19. The method of claim 17, wherein the predetermined period of time is longer than the time interval.

20. The method of claim 15, further comprising:
sorting each of the plurality of objects from a highest confidence score to a lowest confidence score; and
associate one object of the plurality of objects with the highest confidence score with the object transport vehicle on a condition that the confidence score for the one object exceeds the threshold, wherein the one object is physically loaded on the object transport vehicle.
